(19) United States
(12) Patent Application Publication
(10) Pub. No.: US 2017/0152126 A1
(43) Pub. Date: Jun. 1, 2017

(54) SYSTEM AND METHOD OF OPERATING A GOVERNOR WITH INDEPENDENT THRESHOLD SPEEDS

(71) Applicant: Otis Elevator Company, Farmington, CT (US)

(72) Inventor: Randall S. DUBE, Glastonbury, CT (US)

(21) Appl. No.: 15/320,219

(22) PCT Filed: Apr. 28, 2015
(86) PCT No.: PCT/US2015/028026

§ 371 Date: Dec. 19, 2016

Related U.S. Application Data
(60) Provisional application No. 62/013,672, filed on Jun. 18, 2014.

(51) Int. Cl. B66B 5/04; B66B 5/00; B66B 9/00

(52) U.S. Cl. CPC B66B 5/044; B66B 9/00; B66B 5/0031; B66B 5/16

(57) ABSTRACT

A governor system for an elevator is provided including at least one sheave 202, 204. A first centrifugal mechanism 206 rotates concurrently with the at least one sheave 202; and a first retention device 214 limits movement of the first centrifugal mechanism. A second centrifugal mechanism 236 rotates concurrently with the at least one sheave 204; and a second retention device 244 limits movement of the second centrifugal mechanism.

### CROSS REFERENCE TO RELATED APPLICATIONS

The present application is related to, and claims the priority benefit of, U.S. Provisional Patent Application Ser. No. 62/013,672 filed Jul. 23, 2014, the contents of which are hereby incorporated in their entirety into the present disclosure.

TECHNICAL FIELD OF THE DISCLOSED EMBODIMENTS

The presently disclosed embodiments generally relate to elevator systems, and more particularly, to a governor for an elevator.

### BACKGROUND OF THE DISCLOSED EMBODIMENTS

Common centrifugal mechanism overspeed governor subsystems used in elevator systems are designed to respond to or sense the speed of the elevator. The governor subsystem provides two functions. The first function is to monitor the speed of the elevator to determine whether the elevator has exceeded a first threshold speed. At the first threshold speed, the governor signals the elevator control to initiate stopping of the elevator by interrupting power to the elevator machine and dropping the brake. The second function of the governor subsystem is to monitor the speed of the elevator to determine whether the elevator speed has exceeded a second threshold. Upon exceeding the second threshold, the governor subsystem creates a force input to the safety actuating system to initiate activation of the safeties of the elevator to stop the elevator.

In traditional applications elevators operate at common up speeds and down speeds. Accordingly, the centrifugal mechanism of the governor may open undesirably in the car up direction if the car up speed exceeds the car down second threshold speed potentially causing acoustic noise and/or damage to the governor. A governor that can be set at independent thresholds for car up and down directions enables elevator safety system design flexibility for emerging high speed applications in tall buildings where high speed applications with greater up speed than down speed are becoming important.

### SUMMARY OF THE DISCLOSED EMBODIMENTS

In at least one embodiment, a governor system for an elevator is provided including at least one sheave. A first centrifugal mechanism rotates concurrently with the at least one sheave; and a first retention device limits movement of the first centrifugal mechanism. A second centrifugal mechanism rotates concurrently with the at least one sheave; and a second retention device limits movement of the second centrifugal mechanism. In at least one embodiment, the first retention device and the second retention device are electromagnets. In at least one embodiment, at least one of the first centrifugal mechanism or the first retention device applies a force that correlates to a centrifugal force required to initiate a signal to a control system of the elevator when the elevator is traveling in the up direction. In at least one embodiment, the second retention device applies a force that locks the second centrifugal mechanism when the elevator is traveling in the up direction. In at least one embodiment, at least one of the second centrifugal mechanism or the second retention device applies a force that correlates to a centrifugal force required to initiate a signal to a control system of the elevator when the elevator is traveling in the down direction. In at least one embodiment, the first retention device applies a force that locks the first centrifugal mechanism when the elevator is traveling in the down direction. In at least one embodiment, a first force is applied on the first centrifugal mechanism and a second force is applied on the second centrifugal mechanism, wherein the first force is greater than the second force. In at least one embodiment, the first force correlates to a first speed required to activate a control system of the elevator and the second force correlates to a second speed required to activate the control system of the elevator, wherein the first speed is greater than the second speed.

In at least one embodiment, an elevator system is provided having an elevator car and a governor rope coupled to the elevator car. At least one sheave is rotated by the governor rope. A first centrifugal mechanism rotates concurrently with the at least one sheave; and a first retention device limits movement of the first centrifugal mechanism. A second centrifugal mechanism rotates concurrently with the at least one sheave; and a second retention device limits movement of the second centrifugal mechanism. In at least one embodiment, the first retention device and the second retention device are electromagnets. In at least one embodiment, at least one of the first centrifugal mechanism or the first retention device applies a force that correlates to a centrifugal force required to initiate a signal to a control system of the elevator system when the elevator is traveling in the up direction. In at least one embodiment, the second retention device applies a force that locks the second centrifugal mechanism when the elevator is traveling in the up direction. In at least one embodiment, at least one of the second centrifugal mechanism or the second retention device applies a force that correlates to a centrifugal force required to initiate a signal to a control system of the elevator system when the elevator is traveling in the down direction. In at least one embodiment, the first retention device applies a force that locks the first centrifugal mechanism when the elevator is traveling in the down direction. In at least one embodiment, a first force is applied on the first centrifugal mechanism and a second force is applied on the second centrifugal mechanism, wherein the first force is greater than the second force. In at least one embodiment, the first force correlates to a first speed required to activate a control system of the elevator system and the second force correlates to a second speed required to activate the control system, wherein the first speed is greater than the second speed.

In at least one embodiment, a method of governing the speed of an elevator is provided. The method includes moving a first centrifugal mechanism with centrifugal force when the elevator is moving in an upward direction. The movement of the first centrifugal mechanism is limited with a first retention device. A second centrifugal mechanism is moved with centrifugal force when the elevator is moving in a downward direction. The movement of the second centrifugal mechanism is limited with a second retention device. In at least one embodiment, the method further includes applying a force on the first centrifugal mechanism that correlates to a centrifugal force required to initiate a signal to a control system of the elevator when the elevator is traveling in the up direction; and applying, with the second retention device, a force that locks the second centrifugal mechanism when the elevator is traveling in the up direction. In at least one embodiment, the method further includes applying a force on the second centrifugal mechanism that correlates to a centrifugal force required to initiate a signal to a control system of the elevator when the elevator is traveling in the down direction; and applying, with the first retention device, a force that locks the first centrifugal mechanism when the elevator is traveling in the down direction. In at least one embodiment, the method further includes applying a first force on the first centrifugal mechanism, wherein the first force correlates to a first speed required to activate a control system of the elevator; and applying a second force on the second centrifugal mechanism, wherein the second force correlates to a second speed required to activate the control system of the elevator, wherein the first force is greater than the second force and the first speed is greater than the second speed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic view of an elevator system.

FIG. 2 is a schematic view of an elevator system.

FIG. 3 is a schematic view of a governor for an elevator.

FIG. 4 is a flow chart illustrating the operation of a governor for an elevator.

FIG. 5 is a schematic view of a first side of a governor for an elevator.

FIG. 6 is a schematic view of a second side of a governor for an elevator.

FIG. 7 is a schematic view of an elevator system.

FIG. 8 is a schematic view of an elevator system.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

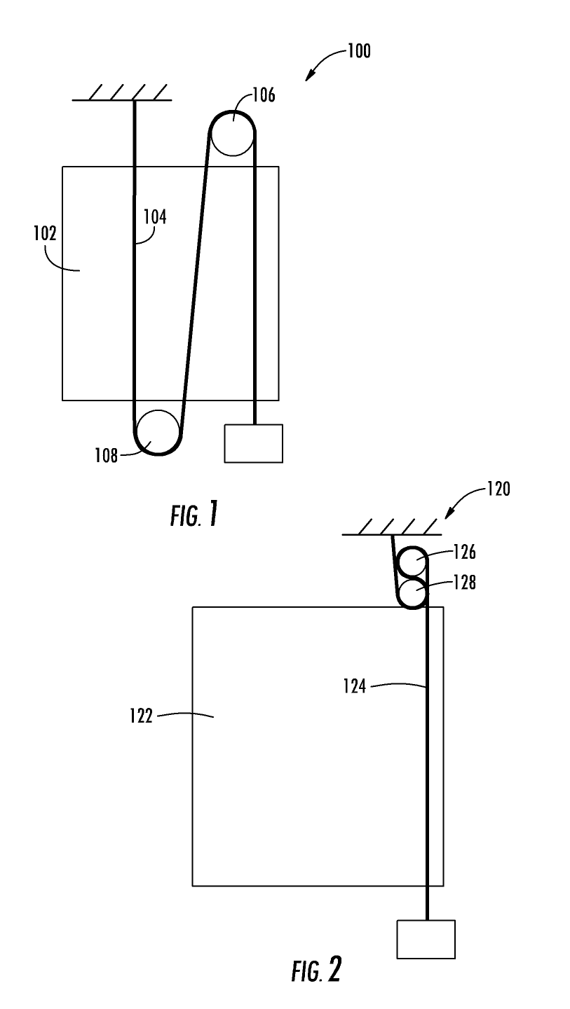

FIG. 1 illustrates an elevator system 100 having a car 102 that is moved in an up direction and a down direction by a hoist rope (not shown). A governor rope 104 rotates an up direction sheave 106 and a down direction sheave 108 while the car 102 moves. In the illustrated embodiment, the up direction sheave 106 is secured above and to the car 102, and the down direction sheave 108 is secured below and to the car 102. The speed of the up direction sheave 106 and the down direction sheave 108 provides a force on centrifugal mechanisms (not shown) that rotate concurrently with the sheaves and are configured to send a signal to the elevator control (not shown) when the elevator speed thresholds are exceeded.

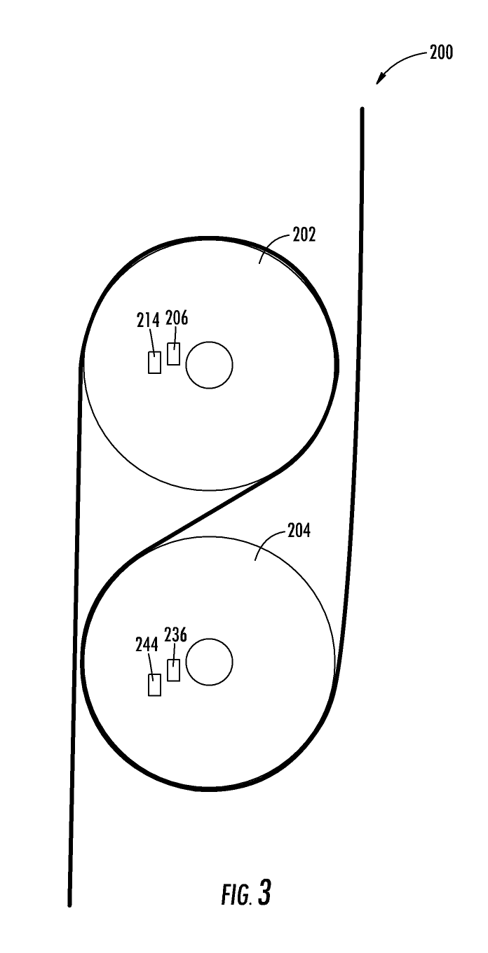

FIG. 2 illustrates an elevator system 120 having a car 122 that is moved in an up direction and a down direction by a hoist rope (not shown). A governor rope 124 rotates an up direction sheave 126 and a down direction sheave 128 while the car 122 moves. In the illustrated embodiment, the up direction sheave 126 and the down direction sheave 128 are both secured above and to the car 122. The speed of the up direction sheave 126 and the down direction sheave 128 provides a force on centrifugal mechanisms (not shown) that rotate concurrently with the sheaves. When the elevator first threshold speed is exceeded the centrifugal mechanisms create a force input to the safety actuating system to initiate activation of the safeties of the elevator to stop the elevator.

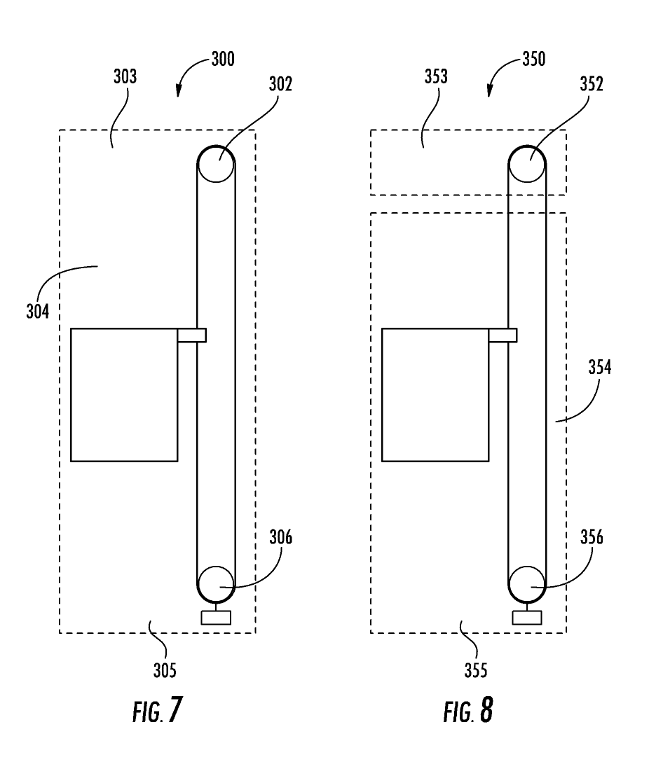

The up direction sheaves 106 and 126, shown in FIGS. 1 and 2 respectively, and the down direction sheaves 108 and 128, shown in FIGS. 1 and 2 respectively, form a portion of a governor system (described in more detail below). Although the sheaves shown in FIGS. 1 and 2 are illustrated as being mounted above and/or below and to the car, it should be noted that the sheaves do not have to be mounted to the car. Alternatively, the sheaves may be located at a top of the elevator shaft, in the elevator pit, in the elevator hoist way, or in a machine room. For example, FIG. 7 illustrates an elevator system 300, wherein an up direction sheave 302 is positioned at a top 303 of a hoist way 304 and a down direction sheave 306 is positioned at the bottom 305 of the hoist way 304. In another example, FIG. 8 illustrates an elevator system 350, wherein an up direction sheave 352 is positioned in a machine room 353 and a down direction sheave 356 is positioned at a bottom 355 of a hoist way 354.

FIG. 3 illustrates a governor system 200 including an up direction sheave 202 and a down direction sheave 204. The up direction sheave 202 rotates at the same speed and on a common rotating shaft with a centrifugal mechanism 206. In particular, the centrifugal mechanism 206 is radially moved by the centrifugal force that is generated by the rotation of the up direction sheave 202. An electromagnetic retention mechanism 214 controls the allowable radial movement of the centrifugal mechanism 206. The retention mechanism 214 may be formed integrally with the centrifugal mechanism 206. In one embodiment, the centrifugal mechanism 206 may include a spring that has a predefined stiffness. The predefined stiffness of the spring along with any calibration intended to adjust the force it applies correlates to a speed threshold of the elevator car and allows the centrifugal mechanism 206 to move radially outward accordingly. Alternatively, the centrifugal mechanism 206 may include an electromagnet that applies a static force to the centrifugal mechanism 206, wherein the applied force correlates to a speed threshold of the elevator. In another embodiment, the centrifugal mechanism 206 may include a permanent magnet that applies a static force, wherein the force correlates to a speed threshold of the elevator. The retention mechanism 214 applies a force on the centrifugal mechanism 206 that correlates to a centrifugal force required to not impede radial outward movement of the centrifugal mechanism 206 in the up direction or prevent its radial outward movement as determined by the elevator control system. The faster the up direction sheave 202 rotates, the more centrifugal force that is applied to the centrifugal mechanism 206 until the force applied to the centrifugal mechanism 206 exceeds the restraining force provided by the spring, permanent magnet, or electromagnet at a required threshold speed. When the force of the retention mechanism 214 is exceeded by the force of the centrifugal mechanism 206, a signal is sent to the control system of the elevator to initiate the application of the machine brakes or to initiate the application of the safety system of the elevator so that the safety system clamps to the rails guiding the elevator. Accordingly, the force applied by the retention mechanism 214 may be controlled to allow or prevent radial outward movement of the centrifugal mechanism 206 to control a maximum speed of the elevator in the up direction.

The down direction sheave 204 rotates at the same speed and on a common rotating shaft with a centrifugal mechanism 236. In particular, the centrifugal mechanism 236 is radially moved by the centrifugal force that is generated by the rotation of the down direction sheave 204. An electromagnetic retention mechanism 244 controls the allowable radial movement of the centrifugal mechanism 236. The retention mechanism 244 may be formed integrally with the centrifugal mechanism 236. In one embodiment, the centrifugal mechanism 236 may include a spring that has a predefined stiffness. The predefined stiffness of the spring along with any calibration intended to adjust the force it provides correlates to a speed threshold of the elevator car and allows the centrifugal mechanism 236 to move radially outward accordingly. Alternatively, the centrifugal mechanism 236 may include an electromagnet that applies a static force to the centrifugal mechanism 236, wherein the applied force correlates to a speed threshold of the elevator. In another embodiment, the centrifugal mechanism 236 may include a permanent magnet that applies a static force, wherein the force correlates to a speed threshold of the elevator. The retention mechanism 244 applies a force on the centrifugal mechanism 236 that correlates to a centrifugal force required to not impede radial outward movement of the centrifugal mechanism 236 in the down direction or prevent its radial outward movement as determined by the elevator control system. The faster the down direction sheave 204 rotates, the more centrifugal force that is applied to the centrifugal mechanism 236 until the force applied to the centrifugal mechanism 236 exceeds the restraining force provided by the spring, permanent magnet, or electromagnet at a required threshold speed. When the force of the retention mechanism 244 is exceeded by the force of the centrifugal mechanism 236, a signal is sent to the control system of the elevator to initiate the application of the machine brakes or to initiate the application of the safety system of the elevator so that the safety system clamps to the rails guiding the elevator. Accordingly, the force applied by the retention mechanism 244 may be controlled to allow or prevent radial outward movement of the centrifugal mechanism 236 to control a maximum speed of the elevator in the down direction.

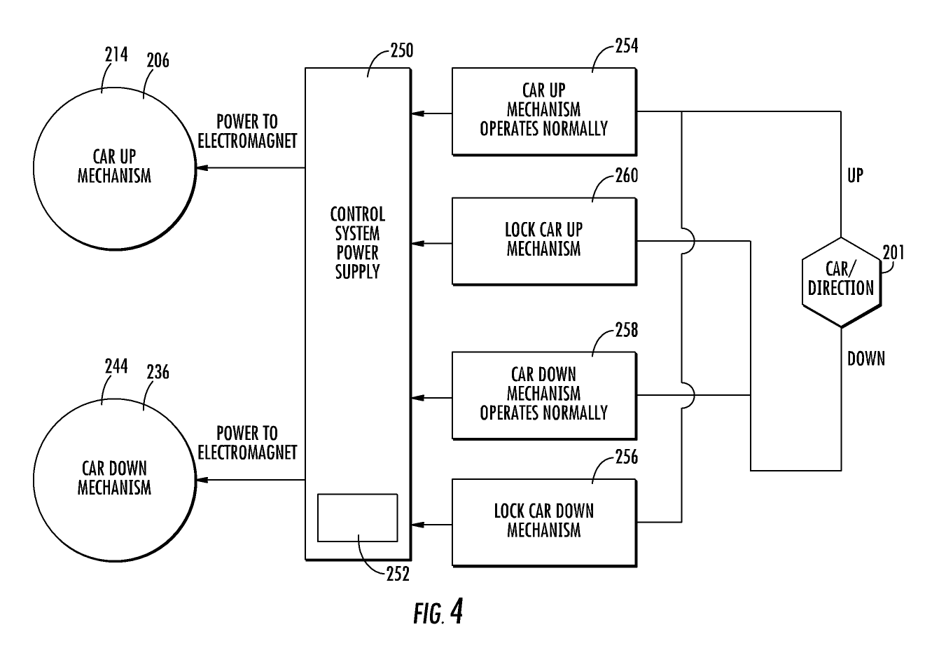

As illustrated in FIG. 4, the retention mechanism 214 and the retention mechanism 244 are electrically coupled to a power supply 250 having an auxiliary power backup 252. The power supply 250 and the auxiliary power backup 252 provide power to the retention mechanisms 214 and 244 to generate a force. The amount of power supplied to the retention mechanisms 214 and 244 correlates to the required electromagnetic force to retain the centrifugal mechanisms 206 and 236, respectively, until the elevator exceeds a threshold speed. If the power supply 250 and the auxiliary power backup 252 both fail, the retention mechanisms 214 and 244 are incapable of generating an electromagnetic force and the centrifugal mechanisms 206 and 236 will not be retained, allowing the centrifugal mechanisms 206 and 236 to operate without limitation potentially applied by the retention mechanisms 214 and 244 in either car direction and consistent with the force elements opposing the centrifugal force generated by the rotational speed of the centrifugal mechanisms 206 and 236 correlated with the car speed, thereby sending a signal to the control system of the elevator to initiate the machine brakes or the safety system at lower speeds. Accordingly, the governor system 200 has a built in safety system if the power supply 250 and the auxiliary power backup 252 both fail.

FIG. 4 further illustrates the operation of the governor system 200. The governor system first determines, at 201, whether the elevator is moving in the upward or downward direction. If moving in the upward direction, the centrifugal mechanism 206 is moved with centrifugal force, i.e. radially outward. The centrifugal mechanism 206 is allowed to operate normally, at 254. Additionally, the retention device 244 applies a force that locks the centrifugal mechanism 236, at 256, to prevent the centrifugal mechanism 236 from inadvertently actuating the safety system of the elevator when the elevator is traveling in the up direction.

If moving in the downward direction, the centrifugal mechanism 236 is moved with centrifugal force, i.e. radially outward. The centrifugal mechanism 236 is allowed to operate normally, at 258 Additionally, the retention device 244 applies a force that locks the centrifugal mechanism 206, at 260, to prevent the centrifugal mechanism 206 from inadvertently actuating the safety system when the elevator is traveling in the down direction.

When moving in the up direction, the retention device 214 applies no force on the centrifugal mechanism 206 allowing the centrifugal mechanism 206 to operate normally, i.e. allowing it to respond based on correlation with car speed to provide a signal to the control system to initiate application of the machine brake or initiate application of the safety system of the elevator so that the safety system clamps to the rails guiding the elevator. When moving in the down direction, the retention device 244 applies no force on the centrifugal mechanism 236 allowing the centrifugal mechanism 236 to operate normally, i.e. allowing it to respond based on correlation with car speed to provide a signal to the control system to initiate application of the machine brake or initiate application of the safety system of the elevator so that the safety system clamps to the rails guiding the elevator. The up threshold force is greater than the down threshold force and the up speed is greater than the down speed.

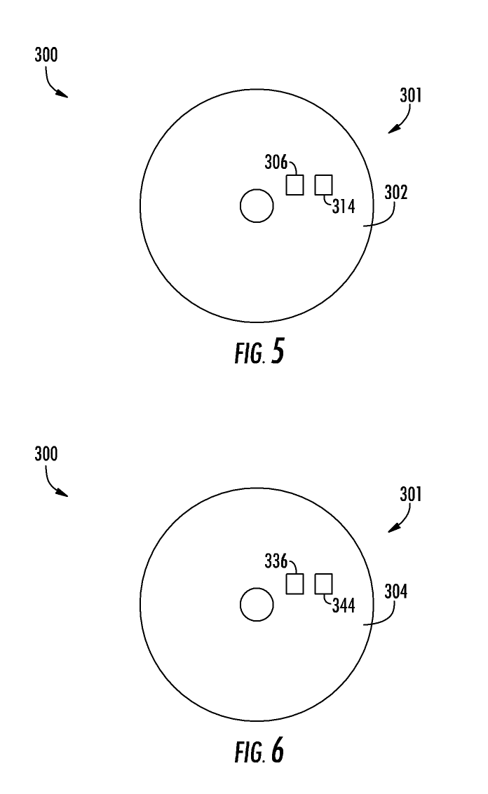

FIGS. 5 and 6 illustrate another embodiment of a governor system 300 including a single sheave 301. A centrifugal mechanism 306 is positioned proximate to a first side 302 of the sheave 301 and rotates with the sheave 301 on a common rotating shaft. The centrifugal mechanism 306 is radially moved by the centrifugal force that is generated by the rotation of the sheave 301 when the elevator car is moving upward. An electromagnetic retention mechanism 314 controls the allowable radial movement of the centrifugal mechanism 306. In one embodiment, the centrifugal mechanism 306 may include a spring that has a predefined stiffness. The predefined stiffness of the spring along with any calibration intended to adjust the force it provides correlates to a speed threshold of the elevator car and allows the centrifugal mechanism 306 to move radially outward accordingly. Alternatively, the centrifugal mechanism 306 may include an electromagnet that applies a static force to the centrifugal mechanism 306, wherein the applied force correlates to a speed threshold of the elevator. In another embodiment, the centrifugal mechanism 306 may include a permanent magnet that applies a static force, wherein the applied force correlates to a speed threshold of the elevator. The retention mechanism 314 applies a force on the centrifugal mechanism 306 that correlates to a centrifugal force required to not impede radial movement of the centrifugal mechanism 306 in the up direction or prevent its radial outward movement as determined by the elevator control system. The faster the sheave 301 rotates, the more centrifugal force that is applied to the centrifugal mechanism 306 until the force applied to the centrifugal mechanism 306 exceeds the restraining force provided by the spring, permanent magnet, or electromagnet at a required threshold speed. When the force of the retention mechanism 314 is exceeded by the force of the centrifugal mechanism 306, a signal is sent to the control system of the elevator to initiate the application of the machine brakes or initiate the application of safety system of the elevator so that the safety system clamps to the rails guiding the elevator. Accordingly, the force applied by the retention mechanism 314 may be controlled to allow or prevent radial outward movement of the centrifugal mechanism 306 to control a maximum speed of the elevator in the up direction.

A centrifugal mechanism 336 is positioned proximate to a second side 304 of the sheave 301 and rotates with the sheave 301 on a common rotating shaft. The centrifugal mechanism 336 is radially moved by the centrifugal force that is generated by the rotation of the sheave 301. An electromagnetic retention mechanism 344 controls the allowable radial movement of the centrifugal mechanism 336. In one embodiment, the centrifugal mechanism 336 may include a spring that has a predefined stiffness. The predefined stiffness of the spring along with any calibration intended to adjust the force it provides correlates to a speed threshold of the elevator car and allows the centrifugal mechanism 336 to move radially outward accordingly. Alternatively, the centrifugal mechanism 336 may include an electromagnet that applies a static force to the centrifugal mechanism 336, wherein the applied force correlates to a speed threshold of the elevator. In another embodiment, the centrifugal mechanism 336 may include a permanent magnet that applies a static force, wherein the applied force correlates to a speed threshold of the elevator. The retention mechanism 344 applies a force on the centrifugal mechanism 336 that correlates to a centrifugal force required to not impede radial movement of the centrifugal mechanism 306 in the down direction or prevent its radial outward movement as determined by the elevator control system. The faster the sheave 304 rotates, the more centrifugal force that is applied to the centrifugal mechanism 336 until the force applied to the centrifugal mechanism 336 exceeds the restraining force provided by the spring, permanent magnet, or electromagnet at a required threshold speed. When the force of the retention mechanism 344 is exceeded by the force of the centrifugal mechanism 336, a signal is sent to the control system of the elevator to initiate the application of the machine brakes or initiate the application of safety system of the elevator so that the safety system clamps to the rails guiding the elevator. Accordingly, the force applied by the retention mechanism 344 may be controlled to allow or prevent radial outward movement of the centrifugal mechanism 336 to control a maximum speed of the elevator in the up direction.

It will therefore be appreciated that the disclosed embodiments enable the elevator to operate at different maximum speeds in the up direction and the down direction.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A governor system for an elevator comprising:
at least one sheave;
a first centrifugal mechanism rotating concurrently with the at least one sheave;
a first retention device to limit movement of the first centrifugal mechanism;
a second centrifugal mechanism rotating concurrently with the at least one sheave; and
a second retention device to limit movement of the second centrifugal mechanism.

2. The governor of claim 1, wherein the first retention device and the second retention device are electromagnets.

3. The governor of claim 1, wherein at least one of the first centrifugal mechanism or the first retention device applies a force that correlates to a centrifugal force required to initiate a signal to a control system of the elevator when the elevator is traveling in the up direction.

4. The governor of claim 1, wherein the second retention device applies a force that locks the second centrifugal mechanism when the elevator is traveling in the up direction.

5. The governor of claim 1, wherein at least one of the second centrifugal mechanism or the second retention device applies a force that correlates to a centrifugal force required to initiate a signal to a control system of the elevator when the elevator is traveling in the down direction.

6. The governor of claim 1, wherein the first retention device applies a force that locks the first centrifugal mechanism when the elevator is traveling in the down direction.

7. The governor of claim 1, wherein a first force is applied on the first centrifugal mechanism and a second force is applied on the second centrifugal mechanism, wherein the first force is greater than the second force.

8. The governor of claim 7, wherein the first force correlates to a first speed required to activate a control system of the elevator and the second force correlates to a second speed required to activate the control system of the elevator, wherein the first speed is greater than the second speed.

9. An elevator system comprising:
an elevator car;
a governor rope coupled to the elevator car;
at least one sheave rotated by the governor rope;
a first centrifugal mechanism rotating concurrently with the at least one sheave;
a first retention device to limit movement of the first centrifugal mechanism;
a second centrifugal mechanism rotating concurrently with the at least one sheave; and
a second retention device to limit movement of the second centrifugal mechanism.

10. The governor of claim 9, wherein the first retention device and the second retention device are electromagnets.

11. The governor of claim 9, wherein at least one of the first centrifugal mechanism or the first retention device applies a force that correlates to a centrifugal force required to initiate a signal to a control system of the elevator system when the elevator is traveling in the up direction.

12. The governor of claim 9, wherein the second retention device applies a force that locks the second centrifugal mechanism when the elevator is traveling in the up direction.

13. The governor of claim 9, wherein at least one of the second centrifugal mechanism or the second retention device applies a force that correlates to a centrifugal force required to initiate a signal to a control system of the elevator system when the elevator is traveling in the down direction.

14. The governor of claim 9, wherein the first retention device applies a force that locks the first centrifugal mechanism when the elevator is traveling in the down direction.

15. The governor of claim 9, wherein a first force is applied on the first centrifugal mechanism and a second force is applied on the second centrifugal mechanism, wherein the first force is greater than the second force.

16. The governor of claim 15, wherein the first force correlates to a first speed required to activate a control system of the elevator system and the second force correlates to a second speed required to activate the control system, wherein the first speed is greater than the second speed.

17. A method of controlling the speed of an elevator comprising:
moving a first centrifugal mechanism with centrifugal force when the elevator is moving in an upward direction;
limiting the movement of the first centrifugal mechanism with a first retention device;
moving a second centrifugal mechanism with centrifugal force when the elevator is moving in a downward direction; and
limiting the movement of the second centrifugal mechanism with a second retention device.

18. The method of claim 17 further comprising:
applying a force on the first centrifugal mechanism that correlates to a centrifugal force required to initiate a signal to a control system of the elevator when the elevator is traveling in the up direction; and
applying, with the second retention device, a force that locks the second centrifugal mechanism when the elevator is traveling in the up direction.

19. The method of claim 17 further comprising:
applying a force on the second centrifugal mechanism that correlates to a centrifugal force required to initiate a signal to a control system of the elevator when the elevator is traveling in the down direction; and
applying, with the first retention device, a force that locks the first centrifugal mechanism when the elevator is traveling in the down direction.

20. The method of claim 17 further comprising:
applying a first force on the first centrifugal mechanism, wherein the first force correlates to a first speed required to activate a control system of the elevator; and
applying a second force on the second centrifugal mechanism, wherein the second force correlates to a second speed required to activate the control system of the elevator,
wherein the first force is greater than the second force and the first speed is greater than the second speed.
